(19) United States
(12) Patent Application Publication
(10) Pub. No.: US 2008/0048913 A1
(43) Pub. Date: Feb. 28, 2008

(54) Local Positioning System and Method

(75) Inventors: Francois Macias, Mios (FR); Philippe Fayollas, Le Bouscat (FR)

Correspondence Address: THELEN REID BROWN RAYSMAN & STEINER LLP, P. O. BOX 640640, SAN JOSE, CA, 95164-0640, US

(73) Assignee: Commissariat A L'Energie Atomique, Paris (FR)

(21) Appl. No.: 11/792,152

(22) PCT Filed: Nov. 30, 2005
(86) PCT No.: PCT/FR05/51002

§ 371 Date: May 31, 2007

(30) Foreign Application Priority Data
Dec. 2, 2004 (FR) 0452839

(51) Int. Cl. G01S 5/02

(52) U.S. Cl. 342/463

(57) ABSTRACT

The invention relates to a system for local positioning of a set of at least one element (25, 26, 27) in a building (28) including at least one more or less congested room, which includes a network of at least three stationary sources (30, 31, 32), transmitting signals at frequencies above 500 MHz, a network of receivers (35), with at least three receivers being arranged in a known manner on each element, and at least one component for processing signals (36) transmitted by the sources and signals received by the receivers arranged on each element, in order to determine the position of each element.

### TECHNICAL FIELD

This invention relates to a system and a method for local positioning.

### PRIOR ART

To locate or position an object in nature, it is possible to use the GPS system (“Global Positioning System”) currently with a positioning precision capable of ranging from 1 to 5 cm. This system cannot, however, be used in a building.

To take position measurements in a building, different means exist that may be chosen depending on the precision required.

To take precise measurements, classic direct sighting apparatuses, for example, are used: laser spot tracker, theodolite, telescope, and so on. These apparatuses have a precision of several ppm and can measure, by direct sighting, several dozens of meters. These apparatuses perform very well in clear spaces (not congested), but must be moved to bypass an obstacle.

FIG. 1 thus shows a system for positioning objects of any shape 10, 11, 12 to be positioned or tested, in a building 13, in this case with two levels. Two laser spot trackers 14 and 15 each comprising a head capable of moving 360° in the horizontal plane and scanning 60° in altitude, transmitting beams 16 and 17. Reflectors 18 and 19 attached to the objects, on the ground or on the walls, which act as reference points, reflect these beams. The lasers then receive the beams thus reflected and calculate the distances and the angles of the objects 10, 11 and 12 with respect to a common reference R. The aperture 20 makes it possible to take measurements between floors in order to use, for example, the reference points of the lower floor in the upper floor. Such a system makes it possible to achieve a precision of 10 ppm.

To position such objects 10, 11, 12 in a building on multiple floors with respect to a common reference R, it is necessary to establish a primary reference network and secondary reference networks at each floor in order to be capable of resetting the direct sighting apparatuses 15, 16 used to take the measurements, for the setting adjustment. The establishment of such networks is very time-consuming because it is necessary to have a minimum number of reference points in order to ensure the required precision. It is an arduous operation, which must be performed periodically in order to take into account the settlement of the building or deformations of the grounds and walls. Once these networks have been established, the positioning and monitoring of such drifts can be performed by installing a measurement apparatus in the vicinity. In addition, these direct sighting apparatuses must be placed in the vicinity of the objects. To monitor a plurality of objects, it is necessary to have a plurality of apparatuses. However, such apparatuses have a high cost. Moreover, their use requires special training.

The invention relates to a system and a method enabling these disadvantages to be overcome while taking a very precise measurement in a congested local zone.

### DESCRIPTION OF THE INVENTION

The invention relates to a system for local positioning of a set of at least one element, or object, in a building including at least one more or less congested room, characterised in that it includes a network of at least three stationary sources, transmitting signals at frequencies above 500 MHz, a network of receivers, with at least three receivers being arranged in a known manner on each element, and at least one component for processing signals transmitted by the sources and signals received by the receivers arranged on each element, in order to determine the position of each element.

The invention also relates to a method for local positioning of a set of at least one element in a building comprising at least one more or less congested room, characterised in that it includes the following steps:

transmitting at least three signals, transmitted by at least three stationary sources, with frequencies above 500 MHz,

receiving said signals by at least three receivers arranged in a known manner on each element,

processing, by at least one processing component, signals transmitted by the sources and signals received by the receivers, in order to determine the position of each element.

Each receiver is advantageously a specific antenna making it possible to obtain the desired precision. The receivers associated with each element are connected to a data acquisition and processing component. Each acquisition and processing component may be connected to a monitoring component or to a local processing component.

In an advantageous embodiment, a multiplexer is arranged between the receivers and a processing component.

In another embodiment, an optical component equipped with at least three submillimetric antennas is arranged on each element. This system can be used to align a laser beam hitting these optical components.

The invention has the following advantages:

no training is necessary to use the system of the invention. It is enough to establish a minimum network of transmitters to cover the entire building;

the information obtained is transmitted in real time. There are fewer constraints than in direct sighting because certain materials can be passed through by the waves transmitted by the sources advantageously covering the volume of the locating area;

a rapid intervention on an object or an equipment can be performed entirely remotely and possibly without human intervention, so as to take measurements or make (powered) adjustments;

the locating of a large number of objects is greatly simplified by the use of the system of the invention (all measurements performed in parallel and in real time);

the positioning precision obtained is less than one millimetre;

the system can be highly flexible: it is absolute with respect to a single primary reference of the building or a plurality of secondary references, on each floor, for example;

in the case of large buildings, a regridding of all of the primary and secondary networks, provided with the direct sighting apparatuses of the prior art, which require considerable work, is no longer necessary;

the system of the invention is perfectly suitable for operation (monitoring of drifts and resetting of the structures). It uses transmitters and receivers, which are calibrated, but which are not considered to be measuring apparatuses: they do not require regular certification, which is an expensive operation;

the system of the invention makes it possible to adjust or monitor the drifts of structures and objects in a large lobby (several dozen metres). Its efficacy is due to the fact that it is very simple to implement and allows for an instantaneous measurement;

the positions of the sources (transmitters) are periodically checked: the knowledge of these drifts makes it possible to reset the measurements with respect to a reference.

The system of the invention can be used in numerous fields, and in particular for:

positioning structures in space (transport structures, etc.),

monitoring the drifts of structures or slabs of a building over time,

aligning a plurality of objects (for example, in optics),

locating objects or monitoring people in a building (security and safety field).

### BRIEF DESCRIPTION OF THE DRAWINGS

FIG. 1 shows a local positioning system of the prior art.

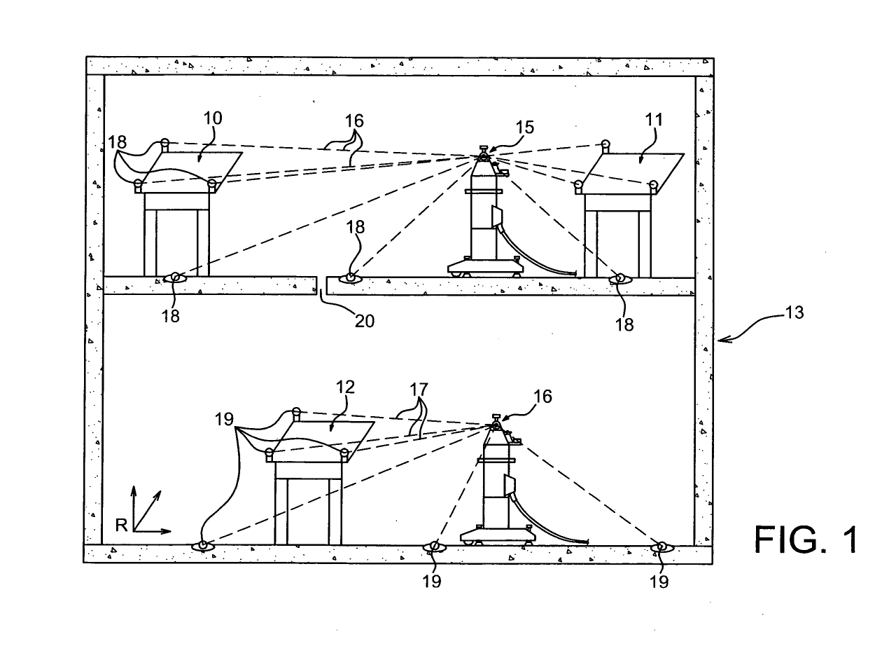

FIGS. 2 and 3 show the positioning system of the invention.

FIGS. 4 and 5 show an embodiment of the system of the invention.

### DETAILED DESCRIPTION OF SPECIFIC EMBODIMENTS

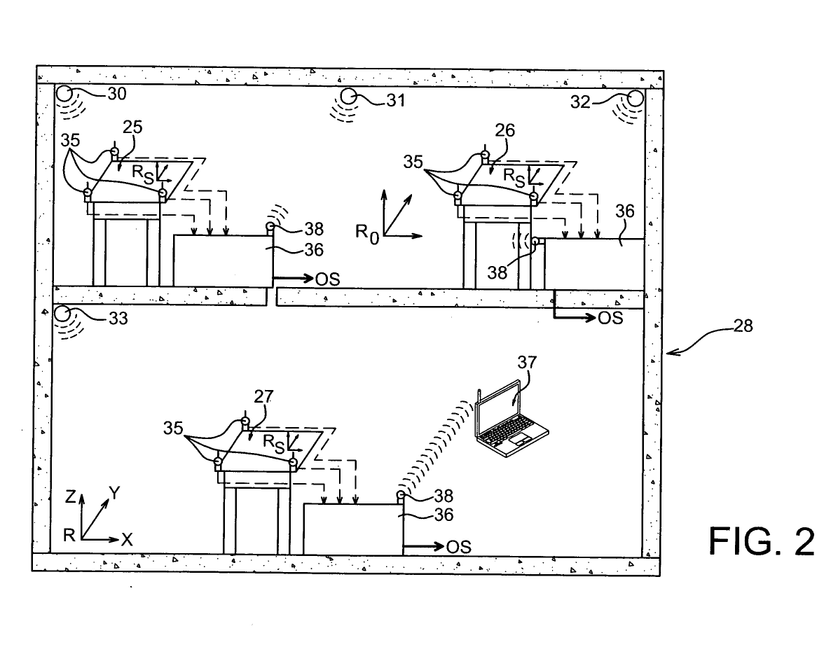

The system of the invention, shown in FIG. 2, is a system for local positioning of a set of at least one element or object 25, 26, 27 in a building 28, in this case including two uncleared rooms, i.e. more or less congested.

This system includes:

a network of at least three stationary sources 30, 31, 32 (possibly 33), for example, attached to the structure of the building 28, transmitting at frequencies greater than 500 MHz,

a network of receivers 35, for example calibrated antennas, attached to the objects of which the position is to be known, at least three receivers being attached in a known manner to each object, wherein these two networks are connected to at least one processing component.

In FIG. 2, the three receivers 35 attached to each object 25, 26, 27 are connected to a data acquisition and processing component 36. This component 36 can be connected to a monitoring component OS, or to a local processing component 37, via a secondary transmitter 38.

This figure shows a primary reference R, corresponding to the building, an origin reference RO, corresponding to a measurement area, and references RS, corresponding to each object.

The system of the invention functions as follows:

the sources 30, 31, 32 (and possibly 33) transmit reference signals, which are received by the receivers 35;

each data acquisition and processing component 36 receives the signals transmitted by the sources and the signals received by the receivers of a corresponding object. It analyses these signals (amplitude and phase), deduces the phase differences due to the distances covered, then calculates the coordinates of the phase centres of each receiver so as finally to locate the position of each of the objects (25, 26, 27);

all of the data collected and processed by a DSP (“Digital Signal Processor”) card 36, can then be transmitted by a wire connection or not to the monitoring component OS so as to provide the position of the structure in the building. This data can also be used by the local processing component 37 by means of a connection with the acquisition and processing component 36 or in a wireless manner by transmission 38.

The system of the invention therefore consists of determining distances between receivers 35 and sources 30, 31, 32, 33 of which the position is precisely known.

By placing at least three of these receivers on each of the objects to be positioned, it is possible to locate each object in space, with respect to a reference R.

By comparison with the devices of the prior art (theodolites, lasers, etc.), the system of the invention makes it possible to take precise measurements in real time without direct sighting with respect to a single reference R. The possible miniaturisation of the receivers can be obtained, for example, with waveguide-type antennas. The use of this type of antenna makes it possible to minimise the uncertainty of the phase centre, for the development of many applications requiring better precision.

As shown diagrammatically in FIG. 3, a receiver 35 receives, at a time tr, the phase of the signal transmitted by a source at a time ts, with phase differences φ1, φ2, φ3 existing between the different signals coming from three sources 30, 31 and 32 in the direction of this receiver. To eliminate the ambiguity concerning the phase (established at an approximate number of full cycles), it is possible to use a method of relative positioning by multi-differences, in which the coordinates of an unknown point are determined using-the coordinates of a known point, on the basis of phase difference values at these two points. Such a method makes it possible to eliminate the integer ambiguities (integer of cycles that the receiver cannot measure).

An object can be located as soon as the position of the receivers with respect to this object has been calibrated. The network of transmitting sources is stationary and fully identified.

In an advantageous embodiment, the information coming from the receivers can be multiplexed and transmitted by means of a wire or an air connection to a processing component, which is responsible for instantaneously collecting all of the positions of the objects. In this way, any user equipped with a portable receiver, for example a portable PC computer (“Personal Computer”), associated with this processing component can check, in real time, any object position on the site.

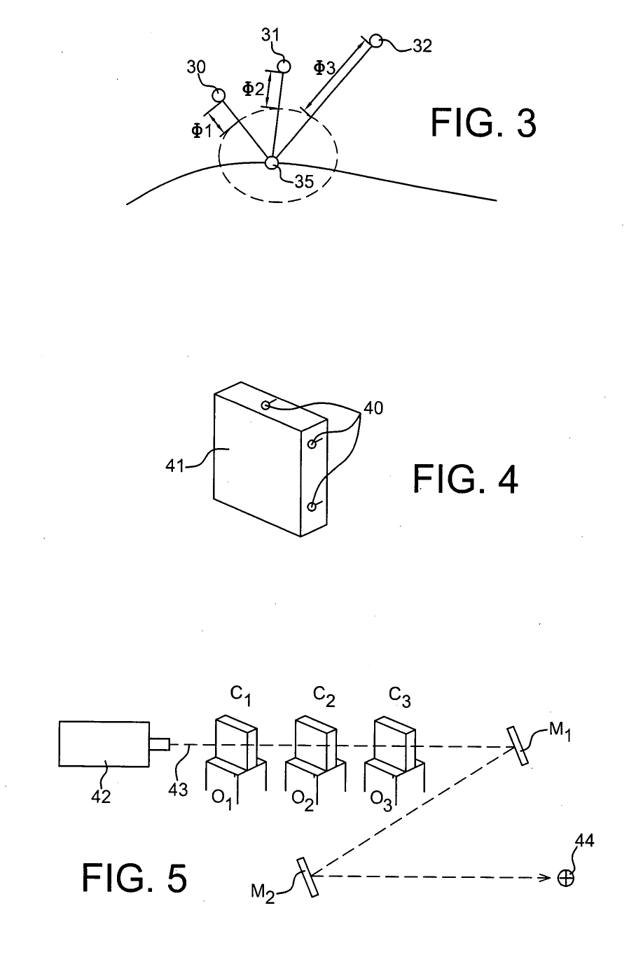

A particularly advantageous embodiment for aligning laser beams consists of arranging at least three submillimetric antennas 40 on the rear surface or the optical component wafers 41 attached to each object. Each optical component, as shown in FIG. 4, is arranged on an object that is itself positioned by the system of the invention. This can be a transparent plate, a mirror, and so on. For optical alignment requirements, it is necessary to know the position of its centre so as to correct it. Each optical component is, to this end, integrated with a powered mount not shown in the figure, which allows for a change in direction with respect to the beam, attached to the corresponding object.

To align such optical components Ci associated with the various objects Oi, as shown in FIG. 5, the principle of alignment consists of positioning the optical components associated with the objects so that the laser beam follows a theoretical path established so as to end, for example, at a target. The beam 42 coming from a laser 43 thus hits (it can pass through them or be reflected off of them) the components C1, C2, C3 . . . and is reflected by mirrors M1, M2 so as to reach the target 44. A correction can then be made to each component using its associated actuators.

The system of the invention makes it possible to perform this type of alignment in real time in an environment highly congested with structures, partitions, protections, and various other materials that prevent simple measurements with commercial apparatuses. All of the measurements arrive simultaneously and the corrections by means of the actuators can be performed simultaneously.

Using a portable receiver, such an embodiment can be open to all in order to check the location of an object in a building (new installation, technical control, material change, readjustment, etc.), without taking any particular precautions. It is enough simply to place the antennas on the object to be measured and to read its coordinates.

This embodiment makes it possible to know the position of each object in space at any time so as to monitor any drift in alignment and to simulate a laser transmission, which makes it possible to reduce the adjustment times of the optics.

The use of such an embodiment can be envisaged in protected places, in order to control visits. In degraded mode, i.e. using a single antenna, it is possible to perform a simple locating operation. A miniature transceiver, for example in the form of a locked bracelet, can be given to each visitor entering a sensitive building to enable them to be monitored in real time and to control their access to risk areas.

Such an embodiment has numerous applications for research centres, which have complex installations requiring positioning and adjustments in space.

1. System for local positioning of a set of at least one element, or object, in a building (28) including at least one more or less congested room, that includes a network of at least three stationary sources, transmitting signals at frequencies above 500 MHz, a network of receivers, with at least three receivers being arranged in a known manner on each element, and at least one component for processing signals transmitted by the sources and signals received by the receivers arranged on each element, in order to determine the position of each element.

2. System according to claim 1, wherein each receiver is an antenna with a minimised phase centre uncertainty.

3. System according to claim 1, wherein the receivers associated with each element are connected to a data acquisition and processing component.

4. System according to claim 3, wherein each data acquisition and processing component is connected to a monitoring component.

5. System according to claim 3, wherein the data acquisition and processing components are connected to local processing components.

6. System according to claim 1, which includes a multiplexer arranged between the receivers and a processing component.

7. System according to claim 1, wherein an optical component equipped with at least three submillimetric antennas is arranged on each element.

8. Method for local positioning of a set of at least one element in a building comprising at least one congested room, including the following steps:
transmitting at least three signals, transmitted by at least three stationary sources, with frequencies above 500 MHz,
receiving said signals by at least three receivers arranged in a known manner on each element,
processing, by at least one processing component, signals transmitted by the sources and signals received by the receivers, in order to determine the position of each element.

9. Method according to claim 8, wherein each receiver is an antenna with a minimised phase centre uncertainty.

10. Method according to claim 8, wherein the receivers associated with each element are connected to a data acquisition and processing component.

11. Method according to claim 10, wherein each data acquisition and processing component is connected to a monitoring component.

12. Method according to claim 10, wherein the data acquisition and processing components are connected to local processing components.

13. Method according to claim 8, which includes a multiplexer arranged between the receivers and a processing component.

14. Method according to claim 8, wherein an optical component equipped with at least three submillimetric antennas is arranged on each element.
